(19) United States
(12) Patent Application Publication
(10) Pub. No.: US 2021/0158157 A1
(43) Pub. Date: May 27, 2021

(54) ARTIFICIAL NEURAL NETWORK LEARNING METHOD AND DEVICE FOR AIRCRAFT LANDING ASSISTANCE

(71) Applicant: THALES, Courbevoie (FR)

(72) Inventors: Thierry GANILLE, Mérignac (FR); Jean-Emmanuel HAUGEARD, Gennevilliers (FR); Andrei STOIAN, Gennevilliers (FR)

(21) Appl. No.: 17/084,501

(22) Filed: Oct. 29, 2020

(30) Foreign Application Priority Data
Nov. 7, 2019 (FR) 1912482

(51) Int. Cl. G06N 3/08; G05D 1/10

(52) U.S. Cl. CPC G06N 3/08; G05D 1/101

(57) ABSTRACT

A neural network learning method for aircraft landing assistance, the method includes receiving a set of labeled learning data comprising sensor data associated with a ground truth representing at least a landing runway and an approach light bar; running an artificial neural network deep learning algorithm on the learning data set, the deep learning algorithm using a cost function called runway threshold trapezium, parameterized for the recognition of a runway threshold and of approach light bars; and generating a trained artificial intelligence model for landing runway recognition.

### CROSS-REFERENCE TO RELATED APPLICATIONS

This application claims priority to foreign French patent application No. FR 1912482, filed on Nov. 7, 2019, the disclosure of which is incorporated by reference in its entirety.

### FIELD OF THE INVENTION

The invention relates to the field of landing assistance systems for aircraft based on embedded cameras or imaging sensors.

### BACKGROUND

The invention more specifically addresses the issue of assistance in landing aircraft on a landing runway in difficult weather conditions, in particular conditions of reduced or degraded visibility in case of fog for example.

The air standards impose rules for obtaining visibility during the landing phase. These rules are translated into decision thresholds which refer to the altitude of the aeroplane in its descent phase. At each of these thresholds, identified visual markers must be obtained to continue the landing manoeuvre, without which it should be aborted. Aborted landing manoeuvres represent a real problem for air traffic management and for flight scheduling. It is essential to estimate, before take-off, the capacity to be able to land at the destination based on more or less reliable weather forecasts, and if necessary provide fallback solutions.

So, the problem of landing aircraft in conditions of reduced visibility has been the object in developing several techniques.

One of these techniques is the Instrument Landing System ILS. The ILS system relies on multiple radiofrequency equipment items installed on the ground, at the landing runway level, and a compatible instrument placed on board the aircraft. The use of such a guidance system requires costly equipment and specific qualification of the pilots. It cannot, moreover, be installed in all airports. This system is present in the main airports only because its cost makes its installation in the others prohibitive. Furthermore, new technologies based on satellite positioning systems will probably replace the ILS systems in the future.

A synthetic visualization solution called SVS (“Synthetic Vision System”) allows displaying a terrain and landing runways from the position of the aircraft supplied by a GPS and its attitude supplied by its inertial unit. However, the uncertainty as to the position of the aeroplane and the accuracy of the positions of the runways which are stored in the databases prevent the use of an SVS in the critical phases in which the aircraft is close to the ground, as in landing and take-off. Recently, SVGS (“Synthetic Vision with Guidance System”) solutions add certain controls to an SVS that allow for a limited reduction of the landing minima (the decision height DH is reduced by 50 ft only on the ILS SA CAT I approaches).

Another approach is the augmented vision technique called EVS or EFVS (“Enhanced (Flight) Vision System”) based on the display on a head-up display which allows displaying, on the primary screen of the pilot, an image of the environment in front of the aircraft which is better than natural vision. This solution uses electro-optical, infrared or radar sensors to film the airport environment when an aircraft is landing. The principle is to use sensors that are more powerful than the eye of the pilot in degraded weather conditions, and to embed the information collected by the sensors in the field of view of the pilot, through a head-up display or on the visor of a headset worn by the pilot. This technique relies essentially on the use of sensors to detect the radiation from lamps disposed along the runway and on the approach light bar. Incandescent lamps produce visible light but they also emit in the infrared range. Sensors in the infrared range make it possible to detect this radiation and the detection range is better than that of a human being in the visible range, in degraded weather conditions. Enhanced visibility therefore, to a certain extent, allows improving the approach phases and to limit the aborted approaches. However, this technique relies on the stray infrared radiation from the lamps present in the vicinity of the runway. For the purposes of extending the life of the lamps, the current trend is to replace the incandescent lamps with LED lamps. The latter have a less extensive spectrum in the infrared range. A collateral effect is therefore to bring about a technical obsolescence of the EVS systems based on infrared sensors.

An alternative to infrared sensors is to obtain images by a radar sensor, in the centimetric or millimetric band. Some frequency bands chosen outside of the water absorption peaks exhibit a very low sensitivity in difficult weather conditions. Such sensors therefore make it possible to produce an image through fog for example. However, even though these sensors have a fine distance resolution, they have a far rougher angular resolution than the optical solutions. The resolution is directly linked to the size of the antennas used, and it is often too rough to obtain an accurate positioning of the landing runway at a sufficient distance to perform adjustment manoeuvres.

Solutions using CVS (“Combined Vision Systems”) visualization systems are based on the simultaneous display of all or part of a synthetic image and of a sensor image, for example by superimposition of the different images and possible realignment of the synthetic image on a noteworthy element of the sensor image, or even by embedding of the sensor image in an inset of the synthetic image or even cropping of noteworthy elements or elements of interest from the sensor image and embedding these elements in the synthetic image. The patent application FR3049744 from the applicant describes a CVS solution based on just a synthetic representation of the outside environment, but repositioned when a sensor looking towards the front of the aircraft detects the landing runway (element of interest). In these CVS solutions with realignment of the SVS, the detection of elements of interest on which to realign the SVS, like the landing runway for example, is based on conventional algorithms for detecting straight lines, patterns, etc. The patent U.S. Pat. No. 7,925,117 B2 from Hamza et al. describes one such solution.

The emergence of the use of active sensors, such as LIDAR (“Light Detection and Ranging”) for example or millimetric radars, which are capable of detecting the landing runway from further away and in almost any conditions of visibility, brings much better results than the passive sensors such as IR cameras. However, the data from such sensors do not make it possible to provide the pilot with a sharp and easily interpretable image like an IR image.

There is then the need for assistance in interpreting images to allow the identification of a runway by the pilot, notably in degraded weather conditions, in sensor data from active sensors looking towards the front of the aircraft.

Image processing solutions based on active sensors assign the task of identifying the runway to an algorithm rather than to the pilot. Current image processing techniques use conventional algorithms (detection of straight lines, of corners, etc.) to identify the runway. Now, the recognition of a landing runway in a sensor image in poor visibility can lack reliability with the conventional algorithms. Indeed, each degraded weather condition is particular and certain conditions can render the runway detection algorithms ineffective. The result thereof is then a reduced reliability of piloting or display computers which use imaging for air operations.

There is therefore a need to improve the image processing algorithms for air operations, notably the operations associated with landing in poor weather conditions leading to reduced or degraded visibility.

Furthermore, the current image processing techniques are linked to image typologies which are particular to each sensor, and which are in principle performed by calibration and experience. One limitation is that these image processing techniques are calibrated on the basis of only a few airports. In some cases, flights are performed in clear weather in daytime to calibrate the sensors concerned. However, given the cost of the flights to generate the images, the number of flights remains very limited and consequently the image bank containing all of the collected images remains small. Thus, the current image banks are incomplete because they do not take account of the diversity of weather situations and the variability of the environment (such as the presence of temporary obstacles for example). The volume of such an image bank has to reach a sufficient threshold for the content to be reliable both in terms of accuracy and in terms of geographic coverage.

### SUMMARY OF THE INVENTION

Thus, one object of the invention is to mitigate the drawbacks of the known techniques.

To this end, the object of the invention is to address the abovementioned needs by proposing a solution for aircraft landing assistance, using deep learning machines for the detection of objects, notably artificial neural networks.

An artificial neural network is a system whose design was originally schematically inspired by the operation of biological neurons, and which subsequently tended more towards statistical methods. The neural networks are generally optimized by machine learning methods.

Thus, the great majority of artificial neural networks have a learning or training algorithm, which consists in modifying synaptic weights based on a set of data presented as network input. The aim of this training is to allow the neural network to learn from examples and produce trained artificial intelligence models.

In one embodiment, the artificial neural network is a convolutional neural network CNN.

Advantageously, the artificial intelligence (AI) algorithm implements a specific cost function, developed for the aeronautical context and particularly suited to the recognition of the runway threshold and of the approach light bars of a landing runway. The new cost function is better suited to the problem of detection and of orientation of a runway by detecting a trapezium that more specifically represents the runway threshold and the approach light bars.

In one embodiment, the AI algorithm first applies a segmentation model to obtain the axis of the runway.

In one embodiment, the learning database for implementing the deep learning is constructed collectively and collaboratively, the data being derived from images obtained by sensors embedded on a plurality of aircraft, whether these are images in the visible range, in the infrared range or radar images.

To this end, the invention can implement mechanisms for prompting participation in the collection and the supply of images. Such mechanisms comprise a fair and definite recompense for contributors who provide images and/or who supply the processes on which image processing is based. Indeed, another brake to the improvement of image processing is the low rate of contributors of images and there is a need to urge any producing and/or using actor to participate in the enrichment of the image bank collaboratively and directly. The actors supplying and/or managing image data can be fairly varied, including, in a nonlimiting manner, suppliers of image sensors, aviators, image processing experts, states (designers of navigation procedures), researchers, airlines.

Advantageously, additional images can be obtained by a mechanism for generating synthetic images which are added to the image bank.

Advantageously, the learning database that is constructed within the meaning of the invention contains a very large quantity of data sets which allows having a critical mass that is sufficient to implement deep learning algorithms, and thus improve the reliability of the computers and reinforce the safety of the aeronautical operations based on the use of these image processing techniques.

Advantageously, the data made available in the learning database are used to train different artificial intelligence algorithms to classify the images and detect the objects, notably to train algorithms based on deep neural networks (“Deep Learning”).

In one embodiment, the artificial intelligence algorithm for deep learning is based on a convolutional neural network CNN.

Advantageously, the database of sensor images can be used to validate the robustness or the weakness of different algorithms with respect to different use cases considered to be problematical, and that make it possible to run different algorithms in parallel on a data set present in the image base and detect, on the results supplied, excessive differences between the different algorithms.

The present invention will have numerous fields of application and in particular applications for the detection of runways, of runway outlines, of light bars, of approach light bars.

To obtain the results sought, a computer-implemented method is proposed for neural network learning for aircraft landing assistance, the method comprising the steps of:
receiving a set of labeled learning data comprising sensor data associated with a ground truth representing at least a landing runway and an approach light bar;
running an artificial neural network deep learning algorithm on the set of learning data, said deep learning algorithm using a cost function called runway threshold trapezium, parameterized for the recognition of a runway threshold and approach light bars; and
generating a trained artificial intelligence model for landing runway recognition.

According to alternative or combined embodiments:
the step of execution of a deep learning algorithm is implemented on a convolutional neural network.
the step of execution of a deep learning algorithm comprises several iterations of the prediction error computation on the set of learning data in order to optimize said cost function.
the iterations for the learning are terminated when the error computation is equal to or below a predefined error threshold.
the step of execution of a deep learning algorithm comprises a step of recognition of a trapezoidal quadrilateral defined by the runway threshold and a row of wider lamps positioned before the runway threshold.
the row of wider lamps is positioned at 300 metres before the runway threshold.
the learning data are real or simulated data.

The invention also covers a computer program product comprising code instructions that make it possible to perform the steps of the neural network learning method for aircraft landing assistance that is claimed, when the program is run on a computer.

The invention also covers a neural network learning device for aircraft landing assistance, the device comprising means for implementing the steps of the neural network learning method according to any one of the claims.

Another object of the invention is the use, in the inference phase, of the trained artificial intelligence model obtained by the method according to any one of the claims.

Another object of the invention is a landing assistance system, notably of SVS, SGVS, EVS, EFVS or CVS type with an embedded trained artificial intelligence model generated according to the neural network learning method claimed.

The invention also addresses an aircraft comprising a landing assistance system comprising a trained artificial intelligence model generated according to the neural network learning method claimed.

### BRIEF DESCRIPTION OF THE DRAWINGS

Other features, details and advantages of the invention will emerge on reading the description which is given with reference to the attached drawings that are given by way of example and which represent, respectively:

FIG. 1 an architecture making it possible to implement the method of the invention;

FIG. 2 a convolutional neural network-based image processing architecture according to an embodiment of the invention;

FIG. 3 a method for generating a trained artificial intelligence model for runway and approach light bar recognition according to an embodiment of the invention;

FIG. 4 a representation of an encompassing trapezoidal box generated by the cost function of the learning algorithm of the invention;

FIG. 5 a general architecture of a visualization system that allows implementing a trained artificial intelligence model obtained by the learning method of the invention;

FIG. 6a and FIG. 6b illustrate, on an IR image, the result of image processing according to the method of the invention.

### DETAILED DESCRIPTION

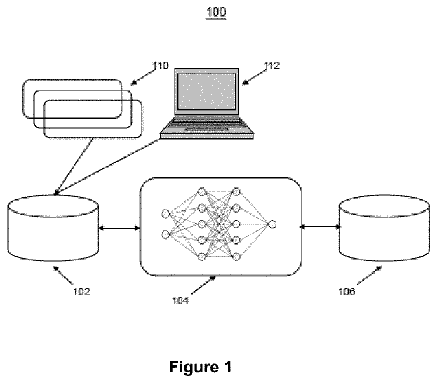

FIG. 1 illustrates an architecture 100 of a system allowing for the processing of sensor images by an artificial neural network algorithm, according to an embodiment of the invention.

The system generally comprises “image supplier” sources 110, 112 capable of sending sensor data to a learning base 102 coupled to an image processing module 104 configured to implement a deep learning algorithm and generate trained artificial intelligence (AI) models.

The learning database 102 should contain a very large quantity of data representing a maximum number of possible situations, encompassing different approaches to different runways with different approach light bars for different weather conditions. In order to implement the deep network learning method of the invention and learn to recognize the landing runway in the data, the database is composed of a plurality of labeled or tagged data sets, in which each set of labeled data corresponds to a pair (sensor data, ground truth VT). A ground truth VT, within the meaning of the present invention, is a description of the different elements of interest that have to be recognized in the sensor data. Such elements represent at least a landing runway and an approach light bar.

The data in the learning base originate from multiple sources 110, 112. They can be real sensor images, whether they are images in the visible range, in the infrared range or radar images. The images are taken by at least one sensor oriented towards the front of an aircraft and capable of supplying information characteristic of a landing runway before the eye of the pilot can see it. This sensor can be an IR camera fixed and positioned in the nose of the aircraft and oriented along the longitudinal axis of the aircraft and usually slightly downwards, supplying a continuous stream of black and white images. The more recent sensors generally combine several specific cameras for different wavelength ranges in the infrared and the visible in order to maximize the capacity of the sensor to detect elements of interest in degraded visibility. Despite these recent advances, this type of sensor does not make it possible to always, in degraded visibility, detect the landing runway before the regulatory minima, typically before the aircraft is below a height of 200 ft above the runway threshold for a category I ILS approach. To mitigate this drawback, the use of active sensors, such as millimetric radars or lidars for example, is being studied. These sensors have a much better capacity to detect elements of interest regardless of the weather conditions. Their drawback is a narrower field, a particular nuisance in cross winds, a lower resolution and a low capacity to generate an image that can readily be interpreted by a pilot. These sensors supply a stream of 3D data (elevation angle, azimuth, distance). The implementation of an automatic landing runway recognition algorithm according to the invention is particularly advantageous with this type of sensor.

The learning base 102 is enriched with images supplied by a multitude of different sensors equipping a plurality of aircraft performing either real flights, or flights purely for taking images. Each image is associated with parameters of the corresponding flight, and notably the 3D position and 3D orientation parameters of the aircraft at the moment of image capture.

In addition, aircraft parameters can be added, such as, for example, heading error, height, or even the distance DME with respect to the runway. In the case of an infrared (IR) image, the associated ground truth is an image of the same size with a specific colour for each element of the image for which recognition is desired to be learned.

Advantageously, simulated sensor data can be added to the learning base in addition to the real data. The simulated data are supplied by an image simulator device 112, capable of generating simulated learning data.

The image suppliers within the meaning of the present invention are understood to be a set of devices in which each device is capable of supplying one or more sensor images. The image suppliers can be a fleet of aircraft, an aircraft within the meaning of the present invention having a generic definition covering any flying vehicle, whether it is an aeroplane, a helicopter, a drone, a balloon, piloted or unmanned.

In one embodiment, the learning data are distributed over a decentralized network of distributed ledger or DLT (“Distributed Ledger Technology”) type which is composed of a plurality of computation entities (processors, computers) and in which a ledger is simultaneously stored and synchronized on the entities of the network. The network can evolve through the addition of new information previously validated by the entirety of the network, and the updating of a distributed ledger is reflected over all of the network. Each device or entity of the network permanently has the latest version of the ledger.

In a particular embodiment, the learning data are distributed over a blockchain, in which each block is linked to the preceding one by a hash key. A block chain is a distributed database secured by cryptographic techniques. Transactions exchanged over the blockchain are grouped together in “blocks” at regular time intervals, securely through cryptography, and form a chain.

In one embodiment, mechanisms for securely time stamping sensor images can be implemented upon the addition of new learning data in the learning base, each sensor image being associated with corresponding flight parameters, sensor parameters and notably identification, 3D position and 3D orientation parameters of the aircraft at the moment of image capture.

In one embodiment, the integrity of the images to be added to the learning base can be validated by a consensus validation algorithm. Notably, the verification of the quality of the sensor images which have to be made available in the base can be done via validation rules dependent on the image suppliers, in particular dependent on the quality of each image supplier, the quality covering the quality of the aircraft and of the crew members, for example for procedures. The validation rules also take account of the quality of actors specializing in image processing who can also validate the quality of the photographs and their use for training the image processing algorithms.

Returning to FIG. 1, the image processing module 104 is configured to implement a deep learning artificial intelligence algorithm on the learning data 102 and generate trained artificial intelligence models (or AI models).

In one embodiment, the trained AI models can be embedded in aircraft, either sent before a flight or downloaded during a flight, for operational use in landing assistance.

In one embodiment, the trained AI models can be stored in a database of trained AI models 106.

The issue addressed by the present invention stems from the fact that the lighting system of the runways of the airports is the essential tool for the safety of the aircraft and their passengers. The lamps which make up the lighting system and their associations allow the pilots to identify the runway in the landing phase, to put the wheels down at the right point, to remain in the axis of the runway and to assess the distance to the end of the runway.

In conditions of degraded visibility, the approach light bar is generally detectable before the landing runway. However, that is not always the case and sometimes, it is in fact the landing runway which can be detectable first, for example in the cases where the light bar is composed of LEDs instead of incandescent lamps, an IR sensor can then detect the runway before the light bar. That is also the case with a radar which, from far away, can detect the contrast between the ground and the asphalt of the runway well before the contrast between the ground and the metal of the light bar whose reflecting surfaces are too small from far away.

In order to obtain the earliest possible detection, it is then important to train the neural network to recognize the different types of light bars, and also recognize the landing runway.

So, the image processing module of the invention 104 implements an artificial neural network deep learning algorithm for runway and light bar detection. In an advantageous embodiment, the algorithm is based on a convolutional neural network CNN.

In the computer vision domain, the objective of the deep learning is to model the data with a high level of abstraction. Synthetically, there are two phases: a learning phase and an inference phase. The learning phase allows defining and generating a trained AI model which meets the operational need. This model is then used in the operational context in the inference phase. The learning phase is therefore of prime importance. In order to obtain the best model, the learning phase demands the prior collection of a large database that is most representative of the operational context and the data to have been labeled with respect to a ground truth (VT).

The ground truth is a reference image which represents a result expected after a segmentation operation. In the context of the invention, the ground truth of an image represents at least a runway and an approach light bar and the visible ground. The result of a segmentation of an image is compared with the reference image or ground truth in order to assess the performance of the classification algorithm.

Learning is considered efficient if it allows defining a predictive model which matches the learning data well but which is also capable of successfully predicting data which have not been seen during learning. If the model does not match the learning data, the model suffers from underlearning. If the model matches the learning data too well and is unable to generalize, the model suffers from overlearning. Thus, from the many labeled images of the learning base 102, the learning phase allows defining the architecture of the neural network and the hyperparameters (the number of layers, the types of layers, the learning pitch, etc.) and to search for the best parameters (the weightings of the layers and between the layers) which best model the different labels (runway/light bar). On each iteration of the learning, the neural network propagates (extracting/abstracting characteristics specific to the objects of interest) and estimates the presence and the position of the objects. From this estimation and from the ground truth, the learning algorithm calculates a prediction error and propagates it backwards in the network in order to update the parameters of the model.

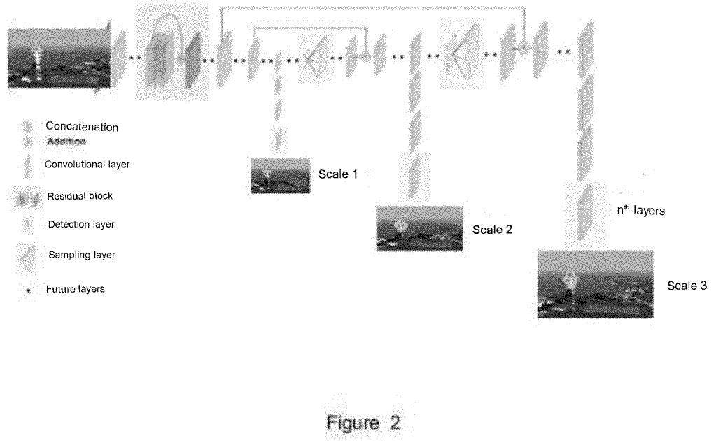

FIG. 2 illustrates an architecture of an image processing module implementing a convolutional neural network CNN, according to an embodiment of the invention. The person skilled in the art will be able to refer to the existing literature to obtain more details on the known structure of the networks of CNN type.

A processing step consists in recognising the light bar as a trapezoidal quadrilateral defined by the runway threshold and a wider row of lamps positioned before the runway threshold. Indeed, on the approach light bars, whatever their type, there is a wider row of lamps, at 1000 feet, or approximately 300 metres, before the runway threshold.

This step is based on the use of a deep neural network which, in the context of the invention, allows detecting a quadrilateral of trapezoidal type, of which the bottom side corresponds to the wider row of lamps 300 metres before the runway threshold and the top side corresponds to the runway threshold.

In one embodiment, the deep neural network for the light bar recognition step is a convolutional neural network based on an architecture of YOLO type, in particular of YOLO v3 type, described in the document “YOLO v3: An Incremental Improvement—Redmon et al. 2018”.

FIG. 2 illustrates an architecture of a CNN network of YOLO v3 type suited to the use case of runway and light bar recognition, with its different hyperparameters (numbers of layers with detection layers, convolutional layers, re-sampling layers). In the context of the runways and light bars, the learning is performed with a specific cost function that addresses the new need for aircraft landing assistance, to detect the runway threshold and the row of lamps 300 metres before the threshold in order to know its relative orientation with respect to the aircraft.

Advantageously, the new cost function is based on the trapezoidal characteristics of a runway threshold and the wider row of lamps before the runway threshold. The neural network seeks to model the parameters of the trapezium, of which the bottom side corresponds to the wider row of lamps before the runway threshold and the top side corresponds to the runway threshold. The detection of the trapezium is performed to different scales (scales 1, 2, 3 in the example illustrated).

In one embodiment, the learning method can comprise an initial step based on the visibility of the light bar.

The initial step consists in recognizing the light bar and its axis when the aircraft is far away and it is not possible to detect the different parts of this light bar. This step is based on the use of a second deep neural network which allows segmenting the light bar instance or object. This step is optional, and the learning method of the invention can implement only the runway recognition step previously described.

In one embodiment, the model of the neural network used for learning light bar recognition uses a “Mask R-CNN—resNet 101” (Regions with CNN features—101 layers) architecture which is described in the document “Mask R-CNN—Kaiming et al. 2017”. In a concrete embodiment using this model, learning by transfer followed by finer learning was performed to adapt to the runway and light bar use case, in which 1900 labeled synthetic images (with runway and light bar seen from different positions and in different day/night conditions) with 30 000 iterations were used to perform the learning.

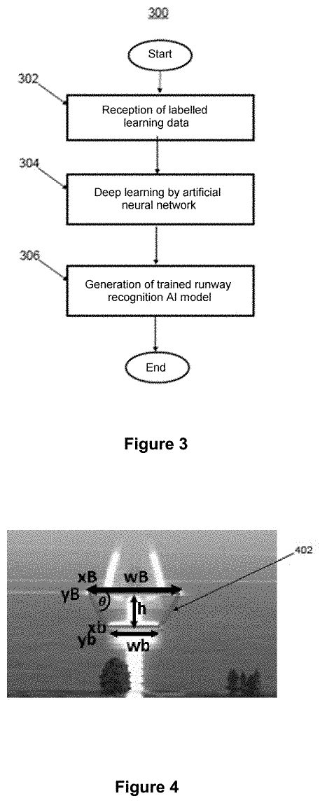

FIG. 3 illustrates a method 300 for generating a model trained by deep neural network for runway and approach light bar recognition according to an embodiment of the invention.

The method begins with the reception 302 of a set of labeled learning data. A set of learning data in the context of the invention consists of a plurality of labeled data, the labeled data corresponding to a plurality of sensor images or radar data in which each image is associated with its ground truth, that is to say a description of the different elements to be recognized in each sensor image. In the case of an image derived from an infrared sensor, the associated ground truth is an image of the same size with a specific colour assigned to each element of the image for which there is a desire for the network to learn to recognize. The ground truth is generated in the phase of construction of the learning database, either manually using a specific tool, or automatically.

In a next phase 304, the method allows for the execution, on the input data, of a deep learning algorithm based on artificial neural networks. In one embodiment, the deep learning algorithm is based on a convolutional neural network CNN as illustrated in FIG. 2.

For an algorithm to be able to learn effectively, an efficiency computation function is defined, generally called cost function, whose result decreases all the more as the model being trained predicts values which approximate observations. In a conventional detection network, the detection is defined by a rectangle (width, height, position on x and position on y). This cost function used in the known learning algorithms, such as the neural networks CNN, presents drawbacks in the aeronautical context. Indeed, it does not allow for a detection that is sufficiently accurate to meet the requisite safety requirements in this field. So, a specific cost function was developed by the inventors so as to adapt to the aeronautical use case of landing runway and light bar recognition. This cost function, called “runway threshold trapezium”, is parameterized to make it possible to more effectively detect a landing runway and the approach light bar, in particular in weather conditions resulting in reduced or degraded visibility, where a standard “rectangular box” cost function does not reliably make this possible. The learning phase comprises error computation iterations on the set of learning data in order to optimize the cost function and converge towards a low error and a high accuracy of the trained model.

FIG. 4 illustrates a representation of a runway threshold trapezium 402 generated by the cost function of the invention during the deep learning process. The runway threshold trapezium (and therefore the cost function) is more complex than a rectangular box because it has to take account of the position and the size of the large base of the trapezium (xB, yB, wB) representing the runway threshold, the position and the size of the small base of the trapezium (xb, yb, wb) representing the wider row of lamps before the threshold (300 metres), the space between these bases (h) and the angle (θ) between the large base and the horizontal axis. These different variables are taken into account in the new cost function to assess the difference between the prediction/detection by the neural network and the ground truth.

In the inference phase, this specific trapezium form is identified by the embedded AI engine. The coordinates in pixels of the corners of the trapezium which is identified are transformed into 3D coordinates to make it possible to calculate the relative position of the aircraft with respect to the threshold and to the runway axis in terms of distance, of height and of lateral drift.

Returning to FIG. 3, after having finished the iterations necessary to the learning, that is to say after having optimized the cost function and obtained an error calculation that is equal to or below a predefined error threshold, the method allows generating, in a subsequent step 306, a model trained for runway recognition.

Advantageously, the trained model can be used in an embedded landing assistance system.

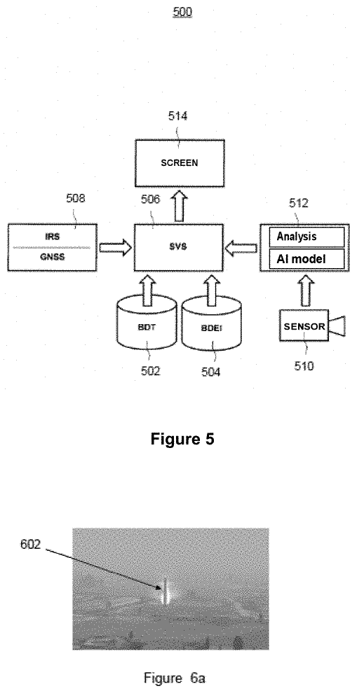

FIG. 5 illustrates a general architecture of a visualization system 500 making it possible to implement, in inference phase, a trained model obtained according to the neural network learning method of the invention.

In a first implementation, a validated AI model (architecture and the hyperparameters learned) can be incorporated in a system embedded on board an aircraft comprising at least one sensor of the same type as that used for the learning. The embedded system 500 comprises a terrain database (BDT) 502, a database of elements of interest (BDEI) 504, a module for generating a synthetic view 506 in 3D towards the front of the aircraft (SVS) from the position and the attitude of the aircraft received by sensors 508, and sensors 510, an analysis module 512 comprising at least one AI module generated according to the method of the invention in a deep learning network learning phase and an SVS display device 514 for the crew of the aircraft. This display device 514 can be a head-down display (HDD), a head-up transparent screen (HUD), a head-worn transparent screen (HWD), the windscreen of the aircraft. Advantageously, the usual piloting symbology showing the pilot parameters of the aircraft (attitude, heading, speed, altitude, vertical speed, speed vector, etc.) is superimposed on the 3D synthetic view. The analysis module 512 can be configured to correct the position of the landing runway shown on the SVS 506. In one embodiment, in which the embedded AI model comprises a model relating to the recognition of the runway axis (obtained in learning phase according to the initial step described previously), in a first stage, the coordinates in pixels of the segment (the axis) detected are sent to the analysis module which calculates, from these coordinates, parameters of the aircraft (attitude and position), of the position of the runway derived from the database and parameters of the sensor, the heading error and the position error perpendicularly to the landing runway.

In a second stage, from the coordinates in pixels of the trapezium which is detected, the analysis module calculates, as previously, the heading error and the position error perpendicularly to the landing runway, but this time, it also calculates the altitude error and the position error longitudinally to the landing runway. All these calculations are performed by comparison with the position data of the landing runway in the terrain database 502, the position and the attitude received by the sensors of the aircraft 508, and the parameters of the sensor 510 (horizontal field, vertical field, orientation, etc.). These calculated errors are then used to improve the accuracy of the input data of the 3D synthetic view generation module which thus shows a view corrected using the detection by the AI model of the landing runway in sensor 510 data. Such a system is called CVS (Combined Vision System) and allows continuing under landing minima if the runway is detected by a sensor.

In another implementation, the embedded system comprises an automatic piloting (PA) device which receives a position and an attitude of the aircraft whose accuracy has been improved as described in the preceding paragraph by the AI model, thus allowing for a lowering of the decision minima and/or an automatic landing of the aircraft. In this implementation, the synthetic view generation module SVS is optional.

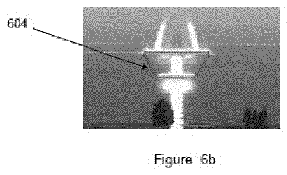

FIGS. 6a and 6b illustrate, on an IR image, the result of an image processing using a trained AI model obtained according to the method of the invention with the version with two recognition steps. In a first stage, a fairly distant view allows the system, using the longitudinal axis of the runway 602, to adjust, if necessary, the SVS in terms of heading and laterally to the landing runway then, on approach, in a second stage, the runway threshold trapezium 604 is detected, allowing the system to identify the runway threshold and the approach light bars, and, if necessary, adjust the SVS, still in terms of heading and laterally to the landing runway, but also in terms of altitude and longitudinally to the landing runway.

Thus, the present description illustrates an implementation of the invention that is preferential, but which is not limiting. Examples are chosen to allow for a good understanding of the principles of the invention and a concrete application, but are in no way exhaustive and should allow the person skilled in the art to make modifications and add variant implementations while retaining the same principles.

The invention can be implemented from hardware and/or software elements. It can be available as computer program product on a computer-readable medium and comprises code instructions for executing the steps of the methods in their different embodiments.

1. A neural network learning method for generating a trained artificial intelligence model, the method comprising:
receiving a set of labeled learning data comprising sensor data associated with a ground truth representing at least a landing runway and an approach light bar;
running an artificial neural network deep learning algorithm on the learning data set, said deep learning algorithm being based on an iterative computation to optimize a cost function called runway threshold trapezium, parameterized for the recognition of a trapezoidal quadrilateral defined by a landing runway threshold and approach light bars; and
generating a trained artificial intelligence model for landing runway recognition.

2. The method according to claim 1, wherein the step of running a deep learning algorithm is implemented on a convolutional neural network.

3. The method according to claim 1, wherein the step of running a deep learning algorithm comprises several iterations of the prediction error computation on the learning data set in order to optimize said cost function.

4. The method according to claim 3, wherein iterations for learning are terminated when the error computation is equal to or below a predefined error threshold.

5. The method according to claim 1, wherein the step of running a deep learning algorithm comprises a step of recognition of a trapezoidal quadrilateral defined by the runway threshold and a wider row of lamps positioned before the runway threshold, notably positioned at 300 metres before the runway threshold.

6. The method according to claim 1, wherein the step of receiving learning data consists in receiving real data or receiving simulated data.

7. A neural network learning device comprising hardware and software means for implementing the steps of the neural network learning method for generating a trained artificial intelligence model, according to claim 1.

8. A use of a trained artificial intelligence model obtained by the method of claim 1 in a landing assistance system in an inference phase.

9. A landing assistance system, notably of SVS, SGVS, EVS, EFVS or CVS type, comprising means for implementing a trained artificial intelligence model generated according to the neural network learning method according to claim 1.

10. The landing assistance system according to claim 9, further comprising means for implementing a trained artificial intelligence model for the recognition of the light bar and of its axis.

11. An aircraft comprising a landing assistance system according to claim 9.

12. A computer program comprising code instructions for executing the steps of the neural network learning method for generating a trained artificial intelligence model, according to claim 1, when said program is run by a processor.
